(19) United States
(12) Patent Application Publication
(10) Pub. No.: US 2023/0202628 A1
(43) Pub. Date: Jun. 29, 2023

(54) ARRANGEMENT TO REDUCE A PROPULSION POWER REQUIREMENT OF A WATERCRAFT

(71) Applicant: Becker Marine Systems GmbH, Hamburg (DE)

(72) Inventor: Henning Kuhlmann, Hamburg (DE)

(73) Assignee: Becker Marine Systems GmbH, Hamburg (DE)

(21) Appl. No.: 17/927,196

(22) PCT Filed: May 28, 2021
(86) PCT No.: PCT/EP2021/064380

§ 371 Date: Nov. 22, 2022

(30) Foreign Application Priority Data
May 28, 2020 (EP) 20177194.6

(51) Int. Cl. B63H 1/28; B63H 25/38; B63H 5/16

(52) U.S. Cl. CPC B63H 1/28; B63H 25/38; B63H 5/16

(57) ABSTRACT

In order to provide an arrangement with at least one rudder and with at least one accommodating space for a propeller, which accommodating space is formed in the direction of travel of the watercraft in front of the rudder and allows for a reduction of a propulsion power requirement of a watercraft with such an arrangement, it is proposed that, in the direction of travel in front of the accommodating space of the propeller, at least one pre-nozzle comprising at least one guide surface and at least one side fin is arranged on the rudder.

The invention relates to an arrangement for reducing a propulsion power requirement of a watercraft, in particular, a ship, comprising at least one rudder and at least one accommodating space for a propeller, said accommodating space being formed in the direction of travel of the watercraft in front of the rudder. Furthermore, the invention relates to a watercraft with such an arrangement.

### TECHNOLOGICAL BACKGROUND

Different devices for reducing the propulsion power requirement of a watercraft are already known. For example, a ring nozzle upstream to the propeller in the direction of travel of a watercraft can optimize an inflow of the propeller and thus have a positive effect on the energy consumption of the watercraft. Further, from EP 2,100,088 B1, a ring nozzle upstream to a propeller with internal guide surfaces is known, which also contributes to reducing the energy consumption of the watercraft.

Furthermore, active devices are known which reduce the friction losses between the water and the hull. Such devices can create air bubbles via nozzles, which are distributed along the hull and reduce the friction of the hull, allowing additional energy savings.

### PRESENTATION OF THE INVENTION: OBJECT, SOLUTION, ADVANTAGES

The object of the invention is to provide an improved arrangement for reducing the propulsion power requirement or for reducing the consumption of a watercraft.

In accordance with one aspect of the invention, this object is achieved by means of an arrangement for reducing a propulsion power requirement of a watercraft, in particular, a ship. The arrangement can preferably be designed as an energy-saving arrangement and be arranged at the stern of a ship's hull.

The arrangement comprises at least one rudder and at least one accommodating space for a propeller in front of the rudder when viewed in the direction of travel of a watercraft. Also, viewed in the direction of travel of the watercraft, at least one pre-nozzle comprising at least one guide surface is arranged in front of the accommodating space of the propeller and at least one side fin is arranged on the rudder. Through this measure, a plurality of energy-saving devices can be combined with each other, which surprisingly results in an even further improved propulsive power and thus in fuel savings.

Depending on the number of propellers provided at the stern of the ship, a plurality of pre-nozzles with guide surfaces and a plurality of rudders with side fins can be used. Preferably, one rudder and one pre-nozzle is assigned to each propeller.

The arrangement can be used, in particular, for medium and large ships, for example, container ships, general cargo ships, bulk carriers, ferries or tankers, in order to achieve fuel savings and thus reduced operating costs of the ship. In particular, the ships can have a maximum speed of at least 15 knots, preferably at least 20 knots, particularly preferably, at least 24 knots.

The at least one rudder of the arrangement may be designed as a so-called full-spade rudder, which is swivel-mounted to the ship's hull only in the upper area. The at least one rudder can be attached to the ship's hull by means of a rudder stock. In addition, the rudder can comprise an optional rudder bulb.

Further preferably, the rudder, in particular full-spade rudder, can be formed as a so-called “twisted rudder”. In this case, an upper rudder blade section may have a different angle of attack with relation to a lower rudder blade section in the region of the leading edges and/or in the region of the trailing edges of the rudder with relation to the propeller flow or the propeller flow direction. The angles of attack of the upper and lower rudder blade section may be constant or, viewed beyond the height of the respective rudder blade section, be continuously or discontinuously different.

In the direction of travel of the watercraft in front of the rudder, an accommodating space is provided for accommodating at least one propeller. The pre-nozzle is located in the direction of travel just before the accommodating space of the propeller. Accordingly, the rudder and the pre-nozzle are spaced away from each other in such a way that there is enough space between the two for providing the propeller (accommodating space). The propeller may preferably be a component of the arrangement. The pre-nozzle comprising the at least one guide surface can optimize an inflow of the propeller. In particular, by means of this, particularly in certain areas of the propeller inflow, a speed increase of the propeller inflow and/or a swirl, in particular, a swirl rotating in opposition to the swirl of the propeller can be generated, which has a positive effect on the thrust generated by the propeller.

The rudder is arranged in the wake flow of the propeller (jet-stream trail of the propeller). The rudder converts part of the energy of the wake flow into buoyancy, the propulsion component of which assists the propulsion of the ship. Due to the optimized propeller flow as described above, the propeller generates an increased thrust and thus a more energetic wake flow. In some areas of the wake flow generated in this way, however, surprisingly increased turbulence occurs. By providing at least one side fin on the rudder, particularly in those areas of the wake flow in which increased turbulence occurs, the wake flow of the propeller can be further optimized. The side fin creates a counter-swirl in the wake flow and thereby improves the thrust of the propeller. Further, the side fin generates additional lift and thereby an additional propulsive force. As a result, the thrust of the already optimized flowing propeller can be further improved, fuel consumption can be further reduced, or the propulsion power can be additionally improved.

The accommodating space of the propeller is located in the direction of travel or in the flow direction between the pre-nozzle and the rudder with at least one side fin. The side fin is preferably attached laterally to the rudder. In particular, the side fin can also be attached to or arranged at a rudder bulb of the rudder, provided that the rudder comprises such a rudder bulb.

The pre-nozzle, the side fin and/or the guide surface of the pre-nozzle may preferably be profiled, i.e., comprise a wing profile, and thus act on a flow of water.

A propeller arranged in the accommodating space can be particularly optimally flowed if the pre-nozzle is shaped as a ring nozzle or as at least a ring nozzle section, wherein the pre-nozzle at least partially circumferentially limits a flow channel. The ring nozzle is circumferentially closed, whereas the ring nozzle section is circumferentially open. Ring nozzle and ring nozzle section may be rotationally symmetrical or rotationally asymmetrical. A flow rate of the flow in the flow channel or in the wake to the flow channel is thereby increased. Due to the addition of at least one guide surface present at the pre-nozzle, an additional twist, in particular, a counter-swirl, is generated in the propeller inflow. These measures can increase the efficiency of the propeller.

A pre-nozzle shaped as a ring nozzle section may have a size corresponding to a circumferential range of a pre-nozzle designed as a full ring nozzle of, for example, greater than, less than or equal to 180°, 90°, or 45°. The ring nozzle section may cover or clamp any angular range. Through a pre-nozzle shaped as a ring nozzle section, a flow can be influenced in a targeted and locally concentrated manner.

In accordance with a further exemplary embodiment, the at least one guide surface of the pre-nozzle is designed in the form of a fin, which is arranged at the ring nozzle or the at least one ring nozzle section. In this case, the fin may preferably be aligned substantially orthogonally to the ring nozzle or the ring nozzle section, in particular, the shell surface of the ring nozzle or the ring nozzle section. Depending on the embodiment, the at least one guide surface may be arranged with respect to the direction of travel of the watercraft with or without angle of attack.

The at least one guide surface may be arranged inside and/or outside the flow channel formed by the pre-nozzle. In particular, if the pre-nozzle comprises a plurality of guide surfaces, guide surfaces may be provided inside and outside the flow channel. Also, a guide surface may be arranged through the nozzle shell continuously and thus inside and outside the flow channel. The guide surfaces may be arranged substantially radially with regard to an rotational axis of the pre-nozzle. The rotational axis of the pre-nozzle may coincide with the propeller axis. Preferably, however, the rotational axis may be shifted upwards with relation to the propeller axis or arranged above the propeller axis. The rotational axis of the pre-nozzle may be parallel or inclined to the propeller axis.

The at least one fin can act on a flow outside the flow channel if it projects from an outer shell surface of the ring nozzle or the ring nozzle section. By this measure, the flow outside the flow channel which is not accelerated by the ring nozzle, or the ring nozzle section, can be induced with a swirl or counter-swirl. It is also possible to use smaller nozzle diameters, which reduces the overall drag of the pre-nozzle.

Further preferred, in embodiments of the pre-nozzle comprising a plurality of guide surfaces, these can be arranged asymmetrically distributed inside and/or outside the pre-nozzle.

According to a further embodiment, the at least one guide surface is designed as a support strut of the pre-nozzle. As a result, the at least one guide surface in addition to influencing the flow can fulfil the task of attaching the pre-nozzle to the ship's hull. The guide surface formed in such a way is preferably arranged within the flow channel of the pre-nozzle and is attached with one end to the ring nozzle or the ring nozzle section, and with its other end to the ship's hull, in particular, in the region of the stern tube.

An additional optimization of the flow in the flow channel can be realized in that the at least one guide surface is completely or partially arranged in the flow channel of the pre-nozzle. This measure can influence the flow of water in the flow channel in such a way that the propeller is flowed into at an area close to the rotational axis with less turbulence.

In accordance with a further exemplary embodiment, the at least one guide surface radially and/or radially extends from an rotational axis of the pre-nozzle beyond the ring nozzle or the ring nozzle section. This measure allows a particularly symmetrical pre-nozzle with guide surfaces to be realized. Simultaneously, the guide surfaces act as fastening elements of the pre-nozzle and enable a positive influence on the entire flow of the propeller in the accommodating space. In particular, a guide surface is arranged both inside as well as outside the flow channel of the pre-nozzle. More preferably, the length of the guide surfaces in this embodiment is greater than the length of the at least one side fin.

A further control of the inflow of the propeller can be achieved by the pre-nozzle comprising a plurality of guide surfaces, which are evenly or unevenly distributed. In particular, predefined local areas of the flow, which are directed to the propeller, can be specifically influenced, in particular induced with a counter-swirl.

According to a further embodiment, the pre-nozzle with the at least one guide surface and the at least one side fin are arranged asymmetrically opposite the rudder in such a way that, in the case of non-deflected rudder position, the at least one side fin is arranged on one side of the rudder and the pre-nozzle with the at least one guide surface is at least partially arranged on another side of the rudder, preferably with a predominant proportion, being particularly preferred, completely. Preferably, the pre-nozzle with the at least one guide surface extends across a first lateral surface of the rudder and the at least one side fin over a second lateral surface of the rudder. The non-deflected rudder position is the zero position at which the rudder angle is zero (e.g., when the watercraft is travelling straight ahead). In particular, when viewed from a rear view of the arrangement or the watercraft, the asymmetrical arrangement results in which the side fin is arranged on one side of the rudder and the pre-nozzle with at least one guide surface is at least partially arranged on another side of the rudder, preferably with a predominant proportion, being particularly preferred, completely. Preferably, in this embodiment of the arrangement, exactly one pre-nozzle and one or a plurality of side fins are present, wherein the one or a plurality of side fins are preferably all arranged on the same side of the rudder. In particular, no side fin is provided on the side of the rudder on which the pre-nozzle is predominantly or completely arranged. In particular, it is preferred that the majority of the guide surfaces of the pre-nozzle, preferably all guide surfaces, are arranged on the side of the rudder opposite to the side fin, meaning on the other side of the rudder.

In addition, in arrangements with more than one rudder, the pre-nozzle may be at least partially arranged on one side of one rudder, preferably with a predominant proportion, being particularly preferred, completely, and the side fin may be arranged on one side of the other rudder, in particular, in such a way that the pre-nozzle and the side fin are arranged on opposite sides of the two rudders.

An asymmetrical arrangement of the pre-nozzle and the side fin has particularly great hydrodynamic advantages and further reduces the propulsion power requirement of a watercraft. Thus, turbulence often occurs in the flow to the propeller in some areas, in the case of right-turning propellers, especially in a range from about 8 o'clock to 12 o'clock in a rear view of the propeller. By arranging the pre-nozzle with its at least one guiding surface in this area, meaning at least partially, predominantly or completely on one side of the rudder, a counter-swirl is generated in the inflow at the appropriate point, whereby the turbulence in the inflow upon impact with the propeller is reduced and the efficiency of the propeller is increased. It has now surprisingly been shown in tests and simulations carried out by the applicant that, in the case of providing a pre-nozzle in the wake flow of the propeller, increased turbulence often occurs on the opposite (other) side of the rudder in such a way that providing at least one side fin on this side is particularly favourable since the side fin thereby positively influences the wake flow in the region of their strongest turbulence and, in particular, the turbulence is reduced by generating a counter-swirl. In propellers rotating to the right, these turbulences often occur in the wake flow in a range from about 2 o'clock to 4 o'clock in a rear view of the propeller so that it can be particularly favourable to provide the at least one side fin in this area.

In accordance with a further embodiment, the pre-nozzle with the at least one guide surface and the at least one side fin are arranged symmetrically with respect to the rudder in such a way that the pre-nozzle and/or the at least one guide surface is arranged both on one side of the rudder as well as on the other side of the rudder. Accordingly, the pre-nozzle and/or the at least one guide surface extend preferably beyond the first lateral surface and the second lateral surface of the rudder. Furthermore, at least one side fin is arranged on the first lateral surface and at least one side fin on the second lateral surface of the rudder. In such an arrangement, a total inflow volume of the propeller and outflow volume of the propeller can be optimized using the pre-nozzle and the side fins.

The at least one side fin is preferably attached to the rudder on one face side, in particular, a lateral surface of the rudder and/or a rudder bulb. The other end of the at least one side fin is preferably formed as a free end.

The at least one side fin may be designed in a particularly simple technical manner and attached to the rudder if it is substantially aligned at a right angle to the first lateral surface and/or the second lateral surface of the rudder.

In a further embodiment, the at least one side fin is aligned at an angle to the first lateral surface and/or the second lateral surface of the rudder, which is less than 90°, preferably less than 75°, being particularly preferred, less than 60°.

In particular, by reducing the angle between the side fin and a lateral surface of the rudder, a width of the rudder may be reduced. As a result, a risk of damage to the side fin in the operation of the watercraft can be reduced and/or the resistance of the arrangement can be reduced. A similar effect may be realized by adjusting a length of the side fin.

If there is more than one side fin, these may be arranged exclusively on one lateral surface of the rudder or on both lateral surfaces of the rudder.

Further optimization of the flow generated by propellers can be achieved if the at least one side fin comprises a tapered sweep. In addition, a tapered sweep of the side fin allows improved slippage of flotsam and reduces the likelihood of damage.

In accordance with a further embodiment, the at least one side fin attached to the rudder comprises a cap arranged on its face side, or a winglet arranged on its face side. In particular, a cap or winglet can be formed or attached to a free end or edge of the side fin. This measure can simplify the detachment of the flow from one edge of the side fin and reduce the hydrodynamic resistance of the side fin.

In accordance with a further aspect of the invention, a watercraft is provided, which comprises an arrangement described in the above. The arrangement may comprise all prescribed embodiments. The watercraft may preferably be a ship comprising a hull with at least one rudder arranged at the stern.

The at least one rudder may, for example, be designed as a full-spade rudder and thus be connected to the hull along a rudder axis in a swivelling manner.

In the direction of travel of the watercraft in front of the rudder, an accommodating space and a propeller located in the accommodating space are provided. The accommodating space can extend transversely to the direction of travel over a plurality of rudders arranged in parallel and can accommodate one or a plurality of propellers.

By equipping the watercraft with the arrangement, energy-saving devices acting in a combinatorial manner are used, in the direction of travel, in front of the propeller and behind the propeller to increase the efficiency of the propeller and the watercraft. Preferably, a pre-nozzle comprising at least one guide surface may be positioned in front of the propeller and the accommodating space to promote an inflow of the propeller.

If a plurality of propellers is positioned in the accommodating space, a plurality of pre-nozzles with guide surfaces may also optionally be used.

In the direction of travel of the watercraft behind the propeller and the accommodating space, a wake flow of the propeller may be optimized by at least one side fin attached to the rudder.

One or a plurality of side fins per rudder and per lateral surface of the rudder may be used. Through the side fins, for example, the thrust generated by the propeller can be aligned in the direction of travel and thus amplified.

### SHORT DESCRIPTION OF THE FIGURES

A plurality of exemplary embodiments of the invention are explained in more detail below on the basis of the drawings. The figures show:

FIG. 1 a lateral view of a stern region of a watercraft with an arrangement in accordance with a first embodiment,

FIG. 2 a top view of the stern region of the watercraft with an arrangement in accordance with a second embodiment,

FIG. 3 a perspective representation of the stern region of the watercraft with an arrangement in accordance with a third embodiment, and

FIG. 4 a further perspective representation of the stern region of the watercraft with an arrangement in accordance with the third embodiment.

### DETAILED DESCRIPTION OF THE FIGURES

In the figures, the same constructive elements each have the same reference numbers.

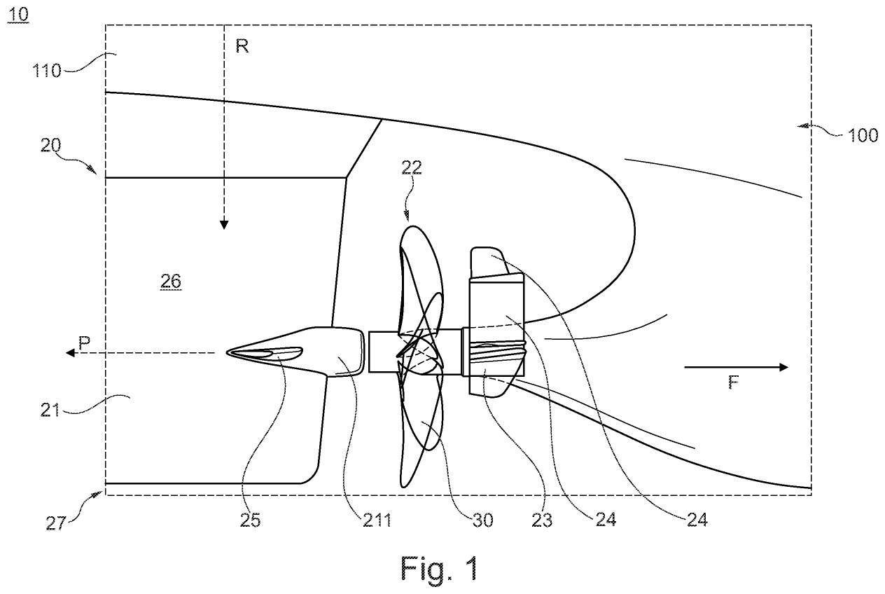

FIG. 1 shows a side view of a stern region 10 of a watercraft 100 with an arrangement 20 in accordance with a first embodiment. In particular, the stern region 10 of the hull 110 of the watercraft 100 is shown.

The arrangement 20 is used to reduce a propulsion power requirement of the watercraft 100. In the exemplary embodiment shown, the watercraft (100) is designed as a ship. As an example, the arrangement 20 only comprises one rudder 21, which is pivotable along a rudder axis R.

In the direction of travel F of the watercraft 100, an accommodating space 22 is provided in front of the rudder 21. In the accommodating space 22, a propeller 30 is positioned as an example.

The propeller 30 is used to drive the watercraft 100 and is rotatable and can be driven around an rotational axis P of the propeller 30 (propeller axis).

In the direction of travel F of the watercraft 100 in front of the accommodating space 22 of the propeller 30, a pre-nozzle 23 comprising a plurality of guide surfaces 24 is arranged. In accordance with the exemplary embodiment shown, the pre-nozzle 24 spans an angular range of 180°, thereby forming an approximately semi-circular ring nozzle section.

In addition, the arrangement 20 has two side fins 25 (due to the side view of FIG. 1, only one side fin is shown; the side fin [not shown] is arranged analogously to the side fin shown on the side of the rudder [not shown]). The side fins 25 are attached to each lateral surface 26, 27 of the rudder 21. Thus, the arrangement 20 is symmetrically designed.

The side fins 25 are connected to the rudder 21 at the level of the rotational axis P of the propeller 30. In the embodiment shown, the side fins are attached to rudder 21 in the region of a rudder bulb 211.

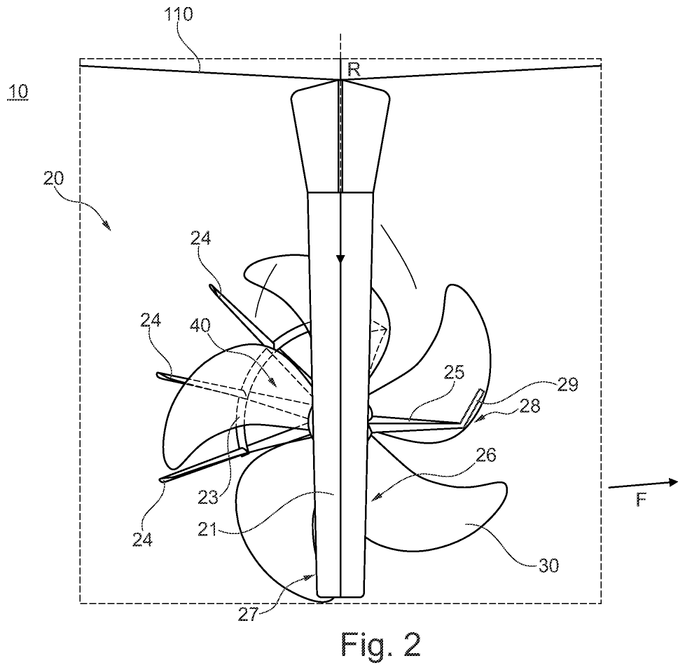

FIG. 2 shows a top view of the stern region 10 of the watercraft 100 with an arrangement 20 in accordance with a second embodiment. In contrast to the first exemplary embodiment, the arrangement 20 is asymmetrically designed. In this case, the pre-nozzle 23 with a plurality of guide surfaces 24 projects laterally over a second lateral surface 27. The pre-nozzle 23 is arranged in particular with its predominant part to one side (the left side of the rudder [port side]) of the rudder 21 shown in figure; only a small subregion projects beyond the other side (starboard side) of the rudder 21. The pre-nozzle 23 spans an angular range of about 120°. In this case, the pre-nozzle 23 is shaped as a profiled ring nozzle section.

The pre-nozzle 23 at least partially circumferentially limits a flow channel 40. The guide surfaces 24 also comprise a profiling and project radially starting from the rotational axis of the pre-nozzle, which coincides in the exemplary embodiment shown with the rotational axis P of the propeller 30, through the flow channel 40 and through the pre-nozzle 23. As an example, three guide surfaces 24 are provided, which are arranged along the rotational axis P of the propeller 30 at uniform angles to each other.

The side fin 25 is attached to a first lateral surface 26 of the rudder 21. The side fin 25 is thus arranged on the other side of the rudder 21 with relation to the majority of the pre-nozzle 23. No side fin is provided on the second lateral surface 27. At a free end 28 of the side fin 25, a winglet 29 is arranged as an example. The winglet 29 may be designed as a single piece with the side fin 25 or subsequently connected to the side fin 25.

The winglet 29 may be directed away in the direction of the hull 110 and/or from the hull 110 of the watercraft 100.

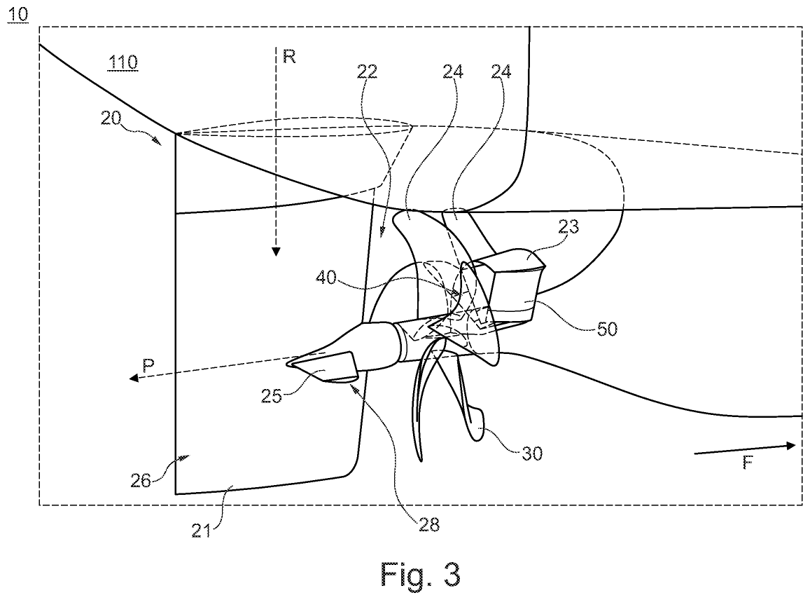

FIG. 3 shows a perspective representation of the stern region 10 of the watercraft 100 with an arrangement 20 in accordance with a third embodiment. In contrast to the embodiment shown in FIG. 2, the arrangement 20 comprises a side fin 25, which comprises a tapered sweep against the direction of travel F and no winglet. Otherwise, the third embodiment is identical to the second embodiment.

Furthermore, it is illustrated in FIG. 3 that at least one guide surface 50 is designed as a support strut of the pre-nozzle 23 on the hull 110 of the watercraft 100.

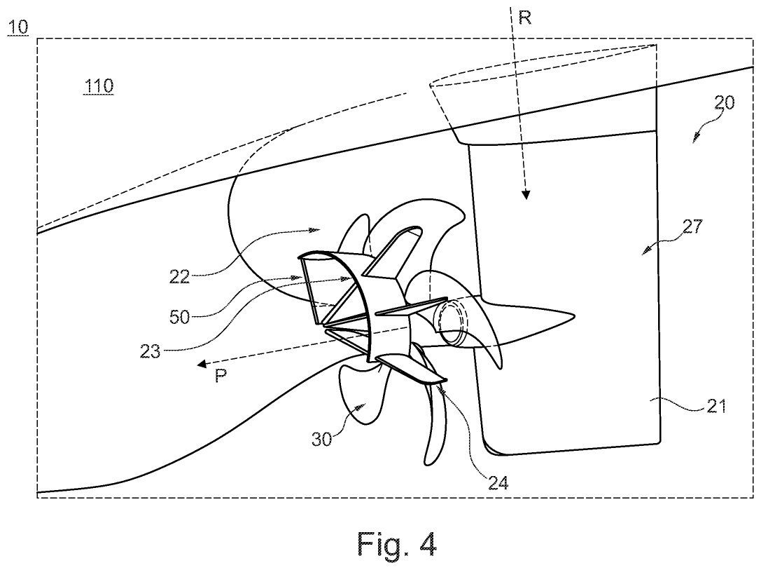

In FIG. 4, a further perspective representation of the stern region 10 of the watercraft 100 with an arrangement 20 in accordance with the third embodiment from FIG. 3 is shown. The asymmetrical structure of the arrangement 20 is illustrated. As an alternative to a pre-nozzle 23 being designed as a ring nozzle section, it may be shaped as a ring nozzle, which covers a 360° angular range and is preferably positioned parallel to the propeller 30.

### REFERENCE LIST

100 watercraft
110 hull
10 stern region
20 arrangement/energy-saving arrangement
21 rudder
211 rudder bulb
22 accommodating space
23 pre-nozzle
24 guide surface
25 side fin
26 first lateral surface of the rudder
27 second lateral surface of the rudder
28 free end/edge of the side fin
29 winglet
30 propeller
40 flow channel
50 guide surface designed as support strut
F direction of travel
P rotational axis of the propeller
R rudder axis

1. An arrangement for reducing a propulsion power requirement of a watercraft, comprising at least one rudder and at least one accommodating space for a propeller, wherein the accommodating space is formed in the direction of travel of the watercraft in front of the rudder, wherein in the direction of travel in front of the accommodating space of the propeller at least one pre-nozzle comprising at least one guide surface is arranged and wherein at least one side fin is arranged on the rudder.

2. The arrangement according to claim 1, wherein the pre-nozzle is shaped as a ring nozzle or as at least one ring nozzle section, wherein the pre-nozzle at least partially circumferentially limits a flow channel.

3. The arrangement according to claim 2, wherein the at least one guide surface of the pre-nozzle is designed in the form of a fin, which is arranged at the ring nozzle or the at least one ring nozzle section.

4. The arrangement according to claim 3, wherein the at least one guide surface designed as a fin projects from an outer shell surface of the pre-nozzle designed as a ring nozzle or as a ring nozzle section.

5. The arrangement according to claim 1, wherein the at least one guide surface designed as a support strut of the pre-nozzle.

6. The arrangement according to claim 1, wherein the at least one guide surface arranged in the flow channel of the pre-nozzle.

7. The arrangement according to claim 2, wherein the at least one guide surface radially extends from an rotational axis of the pre-nozzle beyond the ring nozzle or the ring nozzle section.

8. The arrangement according to claim 1, wherein the pre-nozzle comprises a plurality of guide surfaces, which are evenly or unevenly distributed.

9. The arrangement according to claim 1, wherein the pre-nozzle with the at least one guide surface and the at least one side fin are arranged asymmetrically opposite the rudder in such a way that, in non-deflected rudder position, the at least one side fin is arranged on one side of the rudder and the pre-nozzle with the at least one guide surface is at least partially as arranged on another side of the rudder.

10. The arrangement according to claim 1, wherein the pre-nozzle with the at least one guide surface and the at least one side fin are arranged symmetrically opposite the rudder in such a way that the pre-nozzle and/or the at least one guide surface is arranged both on one side of the rudder as well as on the other side of the rudder, wherein at least one side fin are arranged on the first lateral surface and on the second lateral surface of the rudder.

11. The arrangement according to claim 1, wherein the at least one side fin is essentially aligned at a right angle to the first lateral surface and/or the second lateral surface of the rudder.

12. The arrangement according to claim 1, wherein the at least one side fin is aligned at an angle to the first lateral surface and/or the second lateral surface of the rudder, which is less than 90°.

13. The arrangement according to claim 1, wherein the at least one side fin comprises a tapered sweep.

14. The arrangement according to claim 1, wherein the at least one side fin attached to the rudder comprises a cap arranged on its face side, or a winglet arranged on its face side.

15. Watercraft comprising an arrangement for reducing a propulsion power requirement of the watercraft, said arrangement comprising at least one rudder and at least one accommodating space for a propeller wherein the accommodating space Is formed in the direction of travel of the watercraft in front of the rudder, wherein, in the direction of travel in front of the accommodating space of the propeller, at least one pre-nozzle comprising at least one guide surface is arranged, and wherein at least one side fin is arranged on the rudder.

16. The arrangement according to claim 9, wherein, in non-deflected rudder position, the at least one side fin is arranged on one side of the rudder and the pre-nozzle with the at least one guide surface is with a predominant proportion arranged on another side of the rudder.

17. The arrangement according to claim 9, wherein, in non-deflected rudder position, the at least one side fin is arranged on one side of the rudder and the pre-nozzle with the at least one guide surface is completely arranged on another side of the rudder.

18. The arrangement according to claim 12, wherein the angle is less than 75°.

19. The arrangement according to claim 12, wherein the angle is less than 60°.
